(19) United States
(12) Patent Application Publication
(10) Pub. No.: US 2003/0225688 A1
(43) Pub. Date: Dec. 4, 2003

(54) Financial account transfer apparatus and method

(75) Inventor: Michael P. Dobbins, Gates Mills, OH (US)

Correspondence Address: Mark S. Svat, Fay, Sharpe, Fagan, Minnich & McKee, LLP, 7th Floor, 1100 Superior Avenue, Cleveland, OH, 44114-2518, US

(73) Assignee: Charter One Financial, Inc.

(21) Appl. No.: 10/287,065

(22) Filed: Nov. 4, 2002

Related U.S. Application Data
(60) Provisional application No. 60/383,886, filed on May 28, 2002.

(51) Int. Cl. G06F 17/60

(52) U.S. Cl. 705/39

(57) ABSTRACT

A software-based apparatus coordinates transferring an old account at an old financial institution to a new account at a new financial institution. A personal profiles database stores a user profile entered using a graphical user interface. The user profile includes at least information identifying the user, the old and new accounts, and an entity such as an employer or utility company that performs automatic money transfers into or out of the old account. A financial institutions database transfers stored information about the old financial institution into the user profile. An entities database transfers stored information about the entity into the user profile. A scheduling processor coordinates communications with the entity, the old financial institution, and the user to switch the money transfers, close the old account, provide user reminders, and the like. A notice forms processor prepares personalized communications using information in the personal profiles database. The communications are sent via an electronic mail server, or are printed out on a printer for mailing.

### BACKGROUND OF THE INVENTION

The present invention relates to the financial arts. It is especially applicable to the maintenance and transfer of financial accounts such as personal or small business bank accounts, and will be described with particular reference thereto. However, the invention will also find application in other financial transactions which involve transferring accounts between financial institutions.

In the competitive banking industry, significant effort is expended by individual banks attempting to induce account-holders to switch or transfer accounts from other banks. Enterprising banks typically offer financial incentives, free gifts, favorable interest rates, free checking, and the like to attract account-holders at other banks.

Research indicates that a primary reason why account-holders do not switch banks is inconvenience. Many modern bank accounts have associated automatic electronic money transfer arrangements with one or more creditors or debitors. For example, an employee account-holder can have a direct-deposit arrangement with his or her employer in which the employee's weekly, bi-weekly, or monthly pay is automatically electronically deposited into the employee's bank account. Similarly, automatic electronic withdrawals by landlords, utility companies, mortgage-holders, and other entities to which the account-holder owes regular periodic payments are becoming increasingly prevalent. Automatic electronic money transfer arrangements are convenient and benefit the consumer account-holder by reducing the number of written checks, saving on mailing postage, and minimizing the likelihood of forgetting to pay a bill on time and thus incurring late payment penalties, credit rating problems, and the like.

However, each electronic money transfer arrangement is also one more entanglement which the account-holder will have to confront in the process of switching or transferring the account to another bank. A modern bank account transfer can be quite complex, for example including: setting up the new account; updating direct-depositing of a weekly or monthly pay; updating automatic withdrawal by electric, natural gas, and telephone utility companies; updating automatic withdrawal by other regular billing entities such as cable television and Internet service provider (ISP) companies; and closing out the old bank account. These inconveniences deter many account-holders from taking advantage of favorable interest rates, free checking, low minimum balances, free gifts, and other incentives offered by banks to entice the account-holder to switch.

A related reason why account-holders may hesitate to switch banks is the risk of inadvertently disrupting automatic money transfer arrangements. For example, if the consumer account-holder neglects to update an automatic withdrawal arrangement prior to closing out the old account or fails to leave enough money in the old account to cover the automated withdrawals prior to switchover, the automatic withdrawal process will fail and the consumer can incur penalties, adverse credit reports, and even shut-off of the service or product associated with the disrupted payment. Furthermore, even if the account-holder attempts to updates an automatic money transfer arrangement, the attempt can fail through an error by the account-holder or the associated entity or contact (e.g., employer, utility company, or the like) resulting in a disruption in the arrangement.

The present invention contemplates an improved apparatus and method that overcomes the above-mentioned limitations and others.

### BRIEF SUMMARY OF THE INVENTION

In accordance with one embodiment of the present invention, a software-based apparatus is disclosed that coordinates transferring an old account at an old financial institution to a new account at a new financial institution. A personal profiles database stores an updatable profile of a user entered using a graphical user interface. The user profile includes at least information identifying the user, the old and new accounts, and an entity or contact such as an employer or utility company that performs automatic money transfers into or out of the old account. A financial institution's database transfers stored information about the old financial institution into the user profile. An entities database transfers stored information about the entity or contact into the user profile. A scheduling processor coordinates communications with the entity, the old financial institution, and the user to switch the money transfers, close the old account, provide user reminders, and the like. A notice forms processor prepares personalized communications using information in the personal profiles database. The communications are sent via an electronic mail server, or printed out on a printer for mailing.

In accordance with another embodiment of the present invention, a storage medium stores a computer program executable on one or more computers. The computer program effectuates a method for transferring an old account at a first financial institution to a new account at a second financial institution, wherein the old and new accounts belong to a user. A user profile is constructed, including at least information on the user and the accounts, and a security password. A contacts list is constructed that includes information on an associated entity that conducts automatic transactions including one of debiting and crediting the old account. An entities database containing information on a plurality of entities that regularly conduct electronic transactions, and a financial institutions database containing information on a plurality of financial institutions, are referenced in constructing the user profile and the contacts list. Communications are constructed based on the user profile and the contacts list that instruct the entity to conduct automatic transactions using the new account subsequent to a first date, and that instruct the first financial institution to close the old account at a second date. The entity and the first financial institution are contacted and the communications are forwarded thereto.

Numerous advantages and benefits of the present invention will become apparent to those of ordinary skill in the art upon reading and understanding the following detailed description.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 depicts an account transfer system in accordance with an embodiment of the present invention;

FIG. 2 shows a flow chart illustrating operational steps in accordance with an embodiment of the present invention;

FIG. 3 shows an exemplary graphical use interface (GUI) window which provides the user with an introduction description of the account transfer system;

FIG. 4 shows an exemplary GUI window which provides a user with the minimum information required for operation of the system;

FIGS. 5A-5C are GUI input displays through which user information is entered into the system;

FIG. 6 shows an exemplary GUI confirmation display confirming completion of the profile setup;

FIG. 7 shows an exemplary GUI dialog window through which a user logs into the system;

FIG. 8 shows an exemplary GUI dialog window for the inputting of entity or contact information;

FIGS. 9A-9B show exemplary GUI dialog windows which permit the printing of correspondence based upon information stored in a users profile;

FIG. 10 shows an exemplary GUI display window depicting correspondence generated by the system;

FIGS. 11A and 11B show exemplary GUI dialog windows which record communications in a personal records archive;

FIG. 12 shows selected feedback and/or reminders about events; and

FIG. 13 shows the interconnections of an account transfer system according to the present invention and associated communication pathways.

### DETAILED DESCRIPTION OF THE INVENTION

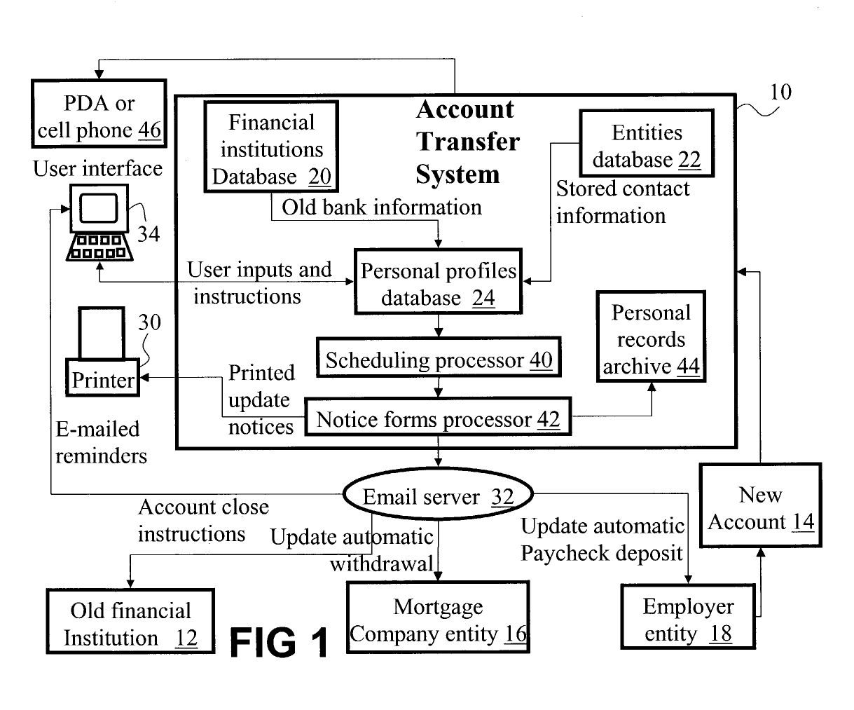

With reference to FIG. 1, a software-based account transfer system 10 is described for assisting a user in switching or transferring an old bank account at a first financial institution 12 (also designated herein as the “old financial institution” or the like) to a new bank account 14 (also designated herein as the “COB account” or the like) at a second financial institution (also designated herein as the “new financial institution” and/or as “COB” or the like). The switching or transferring includes updating automatic money transfers associated with the old bank account. In the exemplary FIG. 1, these automatic money transfers include a monthly automatic withdrawal (debit) by a mortgage company 16, and an automatic payroll deposit (credit) by an employer 18.

The account transfer system 10 includes or has access to one or more non-volatile storage media which embody one or more databases, such as a financial institutions database 20 that contains information corresponding to the old and new financial institutions, an entities database 22 that contains information corresponding to companies or other entities frequently involved with electronic money transfers, and a personal profiles database 24 that contains information about particular accounts of the account transfer system 10. The account transfer system 10 further preferably includes or has access to: at least one printer 30 for printing personalized communications; an electronic mail (email) server 32 by which the account transfer system 10 can send communications to users, financial institutions, companies, and the like; and one or more user interface terminals 34 such as personal computers, bank computer terminals, or the like, which are capable of supporting a user interface (preferably graphical) generated by the account transfer system 10. Interface terminals may also be a personal data assistant (PDA), cell phone or other data transmission device.

In one suitable embodiment, the account transfer system 10 and peripherals (e.g., printers, user terminals, and the like) are associated with the new financial institution at which the new account 14 is being established. Optionally, selected peripherals such as the electronic mail (email) server 32 are associated with an Internet service provider or other outside agency or organization. In one preferred embodiment, at least some of the user interface terminals 34 are personal computers associated with users rather than with the new financial institution. These user-associated terminals communicate with the account transfer system 10 via the Internet, and the account transfer system 10 is accessible by the user at a selected Internet uniform resource location (URL).

Regardless of how the user interface terminal 34 communicates with the account transfer system 10, the user interacts with the user interface terminal 34, preferably via a graphical user interface (GUI), to create a personal profile including name, address, phone number, email, or other personal identifying and/or contact information, which is stored in the personal profiles database 24. In other embodiments the user interface may be accomplished via voice prompting and voice entry systems.

The account transfer system 10 also stores information on entities conducting automatic money transfers (e.g., the mortgage company 16 and employer 18 in FIG. 1) in the personal profile. A scheduling processor 40 coordinates correspondence with the entities 16, 18 and communicates with a notice forms processor 42 to construct personalized letters, emails, and other communications addressed to selected entities to effectuate updating of the automatic money transfer arrangements to the new account 14. Records of the communications produced by the notice forms processor 42 are preferably stored in a personal records archive 44 to assist in tracking the correspondence. Optionally, the user is sent reminders or other notices at a personal communication device 46 such as a personal data assistant (PDA), cellular telephone (cellphone), voice mail box, or the like.

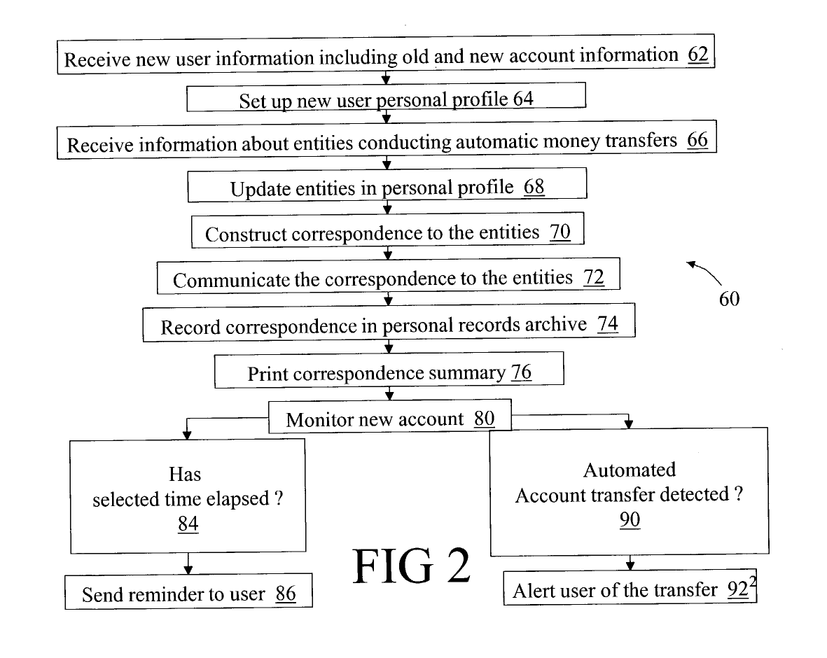

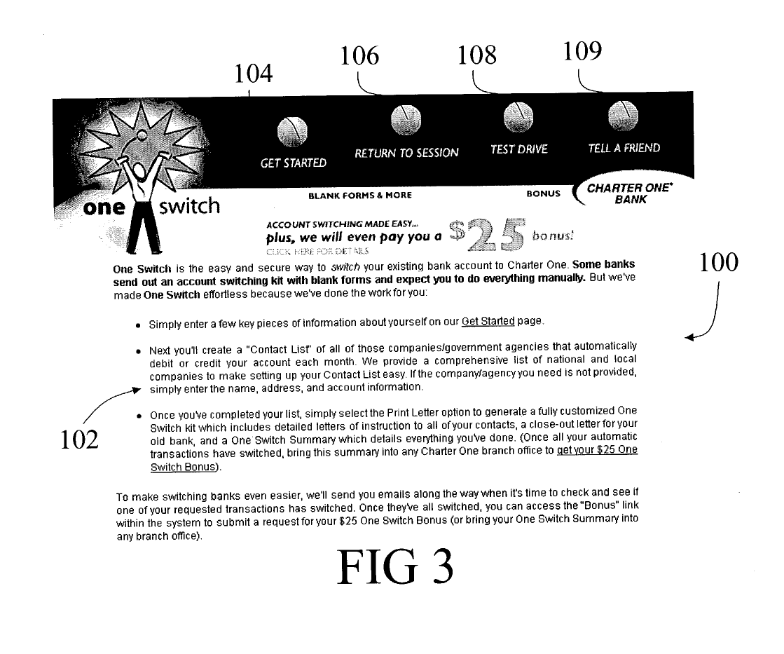

With continuing reference to FIG. 1, and with further reference to FIGS. 2 and 3, a suitable method 60 implemented by the account transfer system 10 is described. In an information receiving step 62, the system receives information about the user and the old and new accounts via the user interface 34. Preferably, a welcoming GUI display 100 (see FIG. 3) provides the user with an introduction description 102 of the account transfer system 10. Suitably, the GUI display also includes user options which can be selected by the user via the GUI, such as a start (“get started”) selection 104, a “return to session” selection 106 that enables the user to return to or update an existing session or account, a “test drive” selection 108 that provides the new user with training or a preview of the account transfer system 10, and the like. A “tell a friend” selection 109 permits a user to print or email special promotional coupons. Direct links to various features (“get started”, “get your $25 One Switch Bonus”) may also be provided within the text on the pages of the application.

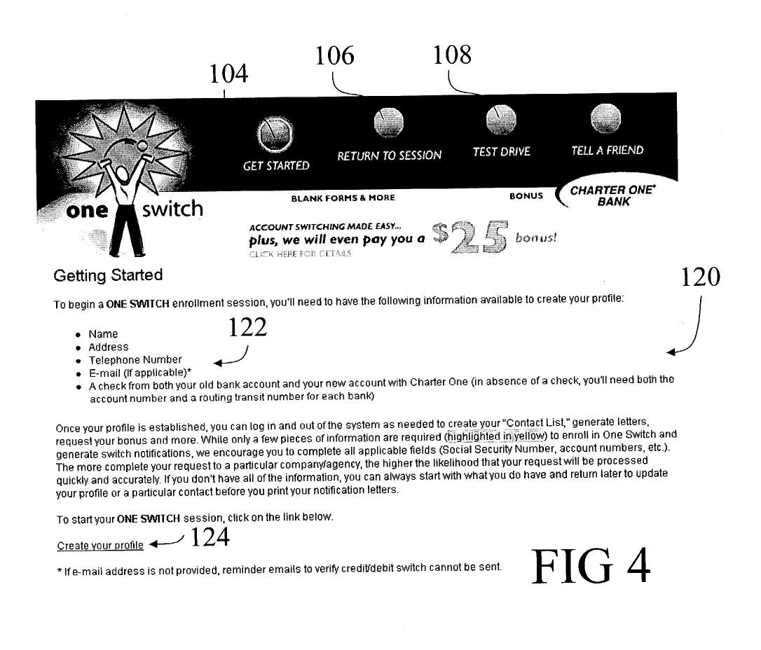

With reference to FIGS. 1-4, responsive to the user selecting the start selection 104, the GUI preferably brings up a preparatory display 120 (see FIG. 4) that informs the user of the minimum information an information receiving step 62 (FIG. 2) will require to establish a new user profile. In the exemplary display 120, a minimum set of information 122 includes the user's name, address, and telephone number, the account number and a routing transit number for the old financial institution 12 (FIG. 1), an account number for the new account 14, and if being performed via the Internet, an electronic mail (email) address. Additional or different minimum information can be requested which is sufficient to identify the user and the old and new accounts. The user selects a continuation selection 124 once the information on the preparatory display 120 is read.

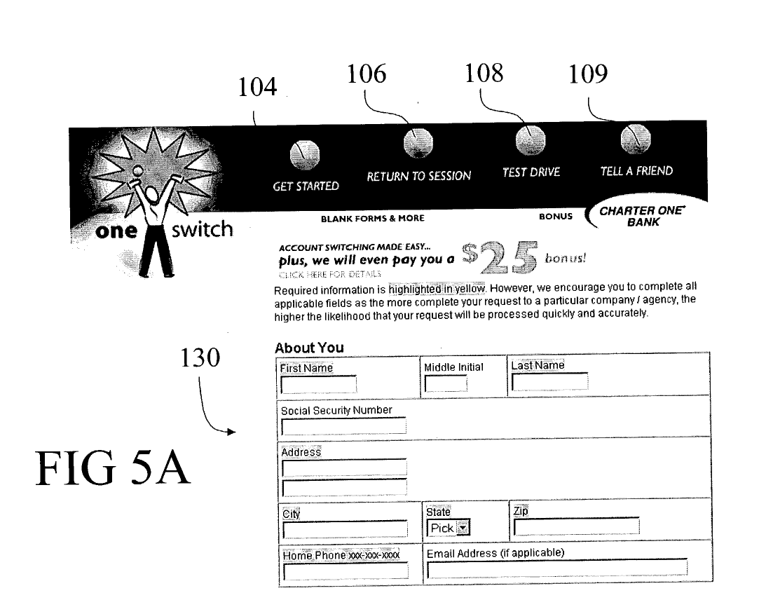

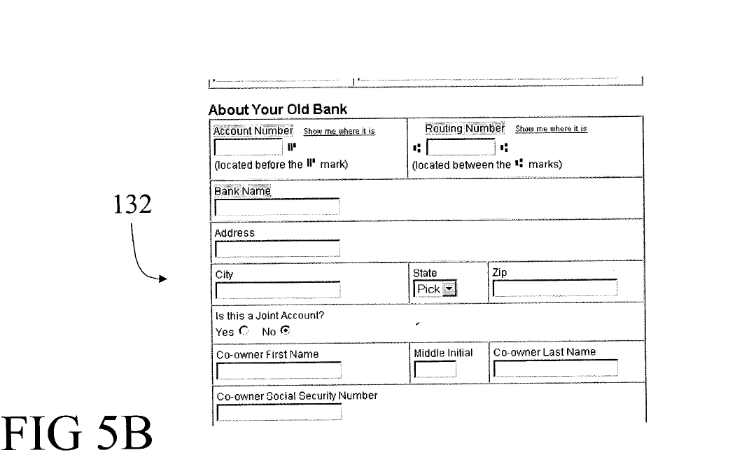

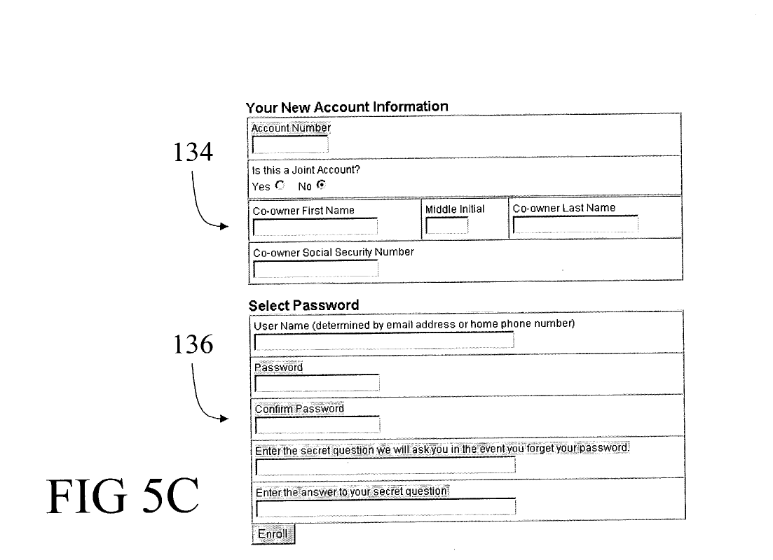

With continuing reference to FIGS. 1 and 2 and with further reference to FIGS. 5A, 5B, and 5C, the GUI next presents the user with one or more input displays through which the account transfer system 10 receives the new user profile information in the information receiving step 62. An input window 130 (see FIG. 5A) entitled “About You” receives information from the user about the user's name, address, and other personal information. An input window 132 (see FIG. 5B) entitled “About Your Old Bank” receives information from the user about the old financial institution 12 and the associated old account including information about any joint accountholders. In particular, the input window 132 asks for the old account number and an identifying number for the old financial institution 12, such as an American Bank Association (ABA) tracking number. Preferably, the financial institutions database 20 (see FIG. 1) is optionally electronically accessed by the user through the input window 132 to obtain information about the old financial institution 12, such as address and routing number, without typing the information in. Particularly, in one embodiment, the user may click on “show me where it is”, and be taken to a screen (not shown) generated by the financial institution's database 20. This screen contains a listing of each financial institution within the United States or a selected area. The user may access the specific information regarding their old financial institution. Once selected, by an import operation, the appropriate information which is available is inputted into the data areas set forth in the input window 132.

An input window 134 (see FIG. 5C) entitled “Your New Account Information” receives information from the new account 14 including the new account number. Preferably, an input window 136 (see FIG. 5C) receives a security password or other information that allows user identity verification in the event that the user returns to the session, e.g. via the return to session selection 106. In a preferred embodiment, the account transfer system may be designed.

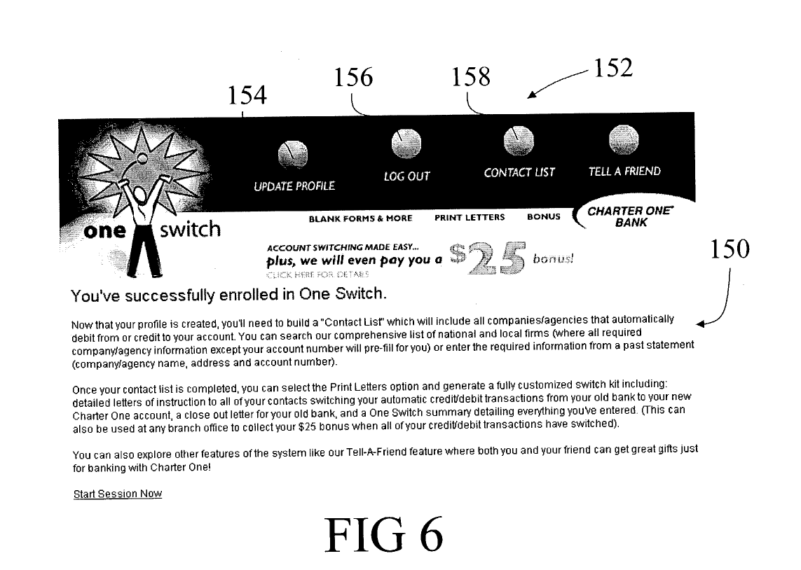

With continuing reference to FIGS. 1 and 2, and with further reference to FIG. 6, once the information receiving step 62 is complete, the account transfer system 10 sets up a new user profile in the personal profiles database 24 for the user in a profile setup step 64. Preferably, the user receives a confirmation display 150 (see FIG. 6) after the profile setup step 64 is complete, which confirms that a new personal profile for the user has been created.

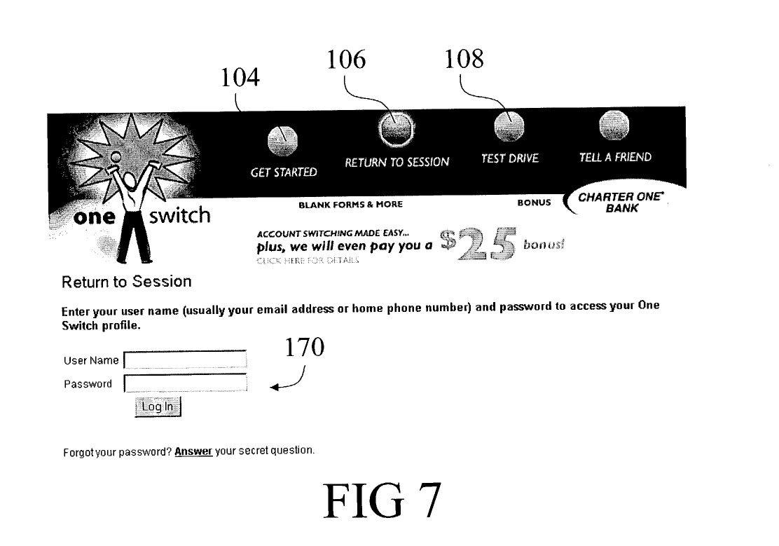

With continuing reference to FIGS. 1, 2, and 6, and with further reference to FIG. 7, the confirmation display 150 (FIG. 6) also preferably provides the user with instructions for interacting with the GUI to supply information about entities or contacts conducting automatic money transfers. As specified in the exemplary confirmation display 150, this information includes the entity or contact name, address, and an entity account number. The confirmation display 150 also preferably provides a user menu 152 that includes an update profile selection 154, a log out selection 156, and a contact list select 158. Typically, however, the user may not have this information immediately available. In this case, the user optionally exits the account transfer system 10, e.g. using the log out selection 156, and returns to the session later using the return selection 106 of the system entry display 100 (see FIG. 3). This brings up a return to session security password display 170 (FIG. 7) where the user identity is verified by receiving the security password or other information that was initially supplied by the user in the input window 136 (see FIG. 5C). Once logged back in, the user is presented with the user menu 152 (see FIG. 6) and selects the contact list selection 158.

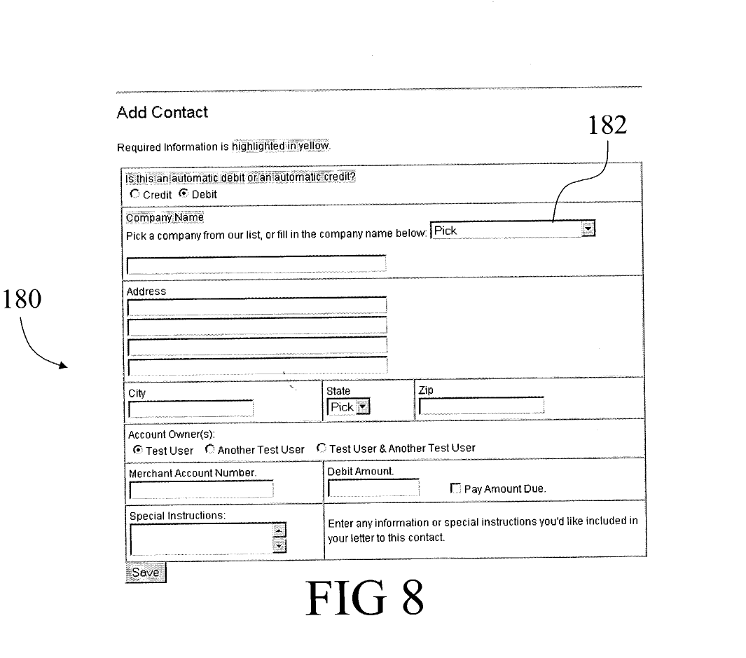

With continuing reference to FIGS. 1 and 2, and with further reference to FIG. 8, the account transfer system 10 requests information in an information request step 66 (see FIG. 2) through an input window 180 (see FIG. 8) about the entity or contact involved in an automatic money transfer arrangement. In the exemplary input window 180, this information includes the type of money transfer (e.g., credit or debit), the name of the company or other entity, address information for same, a merchant account number or other identifier, and the debit or credit amount. Since certain entities are commonly involved in automatic money transfer arrangements (e.g., organizations such as utility companies, Internet service providers, major employers, and the like), the user preferably has the option of electronically accessing information on such entities from the entities database 22 (see FIG. 1) through a drop-down selection box 182 or other convenient GUI input. Automatic accessing of the entity information by the drop-down selection box 182 causes the address and other information to be automatically filled in with information contained in the entities database 22. By electronically accessing the entities database 22 and retrieving information therefrom, the user advantageously does not need to know and physically enter this information into the input window 180.

The information requested in the input window 180 is exemplary only. Additional or different information can be requested. For example, if the automated money transfer does not involve a fixed amount (e.g., a utility bill which varies from month to month) the debit or credit amount can be replaced by a time window in each month during which the transfer is expected to occur. Preferably, the information requested in the input window 180 is not all required. In the input window 180, for example, only highlighted information (debit or credit selection, and company name) is required. However, entry of the additional information will help ensure that the resulting correspondence to that entity generated by the notice forms processor 42 (see FIG. 1) is sufficiently complete to effectuate transferal of the automatic money transfer to the new account 14.

With continuing reference to FIGS. 1, 2, and 8, once the entity information is received in the information request step 66 via the input window 180, the user's personal profile is updated with the entity information in an update entities step 68. The user can select to have the account transfer system 10 construct correspondence to one or more entities or contacts in the personal profile in a construct correspondence step 70 as described next.

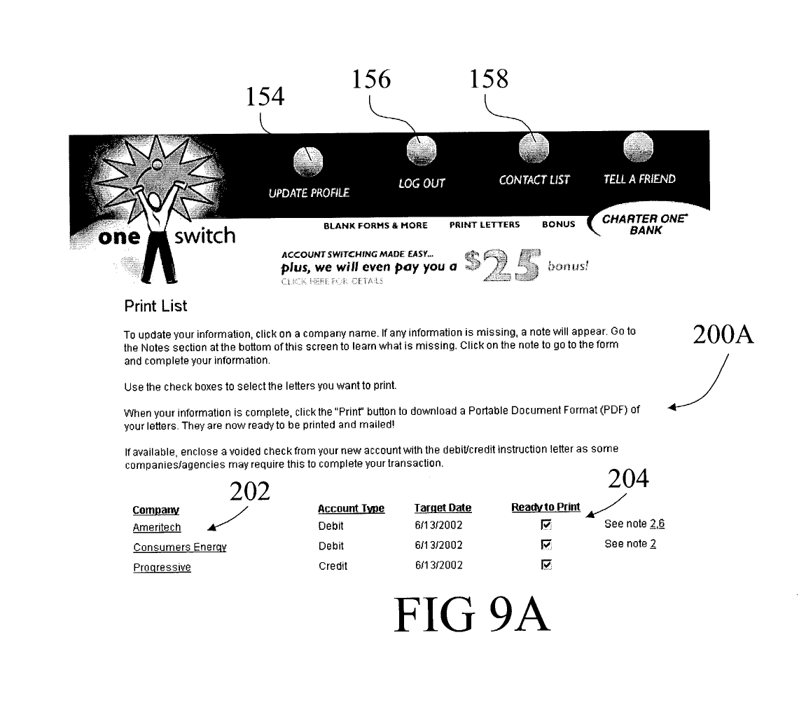

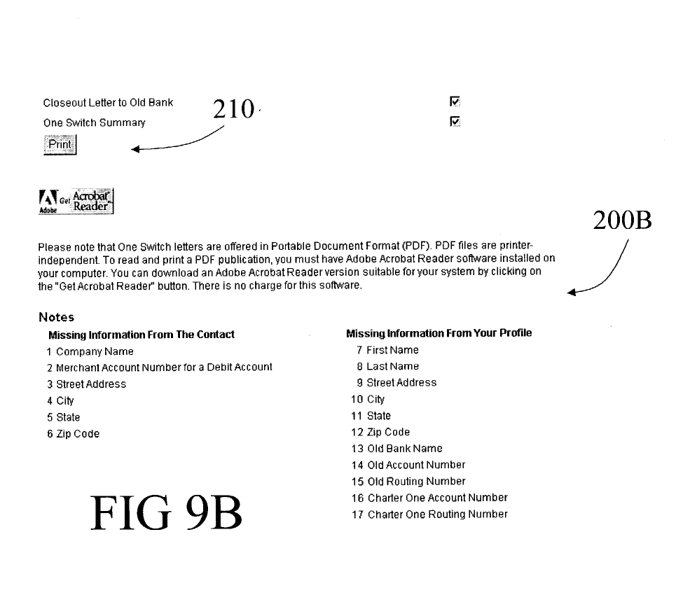

With continuing reference to FIGS. 1, 2, and 8 and with further reference to FIGS. 9A and 9B, the user selects to print correspondence based upon the information stored in the user's personal profile, for example using the “print lefters” hyperlink of the user menu 152 (see, e.g., FIG. 6 or FIG. 9A). The account transfer system 10 generates a display 200A, 200B (see FIGS. 9A and 9B) through which the user can: (1) review a list 202 of entities or contacts whose information has been supplied (e.g. via the input window 180) along with relevant information such as the account type and the target date for switching, corresponding selection boxes 204 through which the user can select to have correspondence prepared and printed or otherwise communicated, and the like.

The entities list 202 also includes notes 206 (see FIG. 9A) which are explained in a notes definitions table 208 (see FIG. 9B). The notes 206 indicate whether any information to be included in the correspondence is missing from the user's profile in the personal profiles database 24. For example, the notes for the entity “Ameritech” indicate a missing merchant account number (note 2) and a missing zip code (note 6). Preferably, the list 202 is hyperlinked such that the user can click on or otherwise select an entity using the GUI and bring up the input display 180 (see FIG. 8) to update information on the entity. In the exemplary embodiment shown in FIG. 9B, the correspondence is printed in Portable Document Format (PDF); of course, other formats can be employed. Selection of a print selection 210 (see FIG. 9B) by the user via the GUI initiates printing of the correspondence indicated by the selection boxes 204.

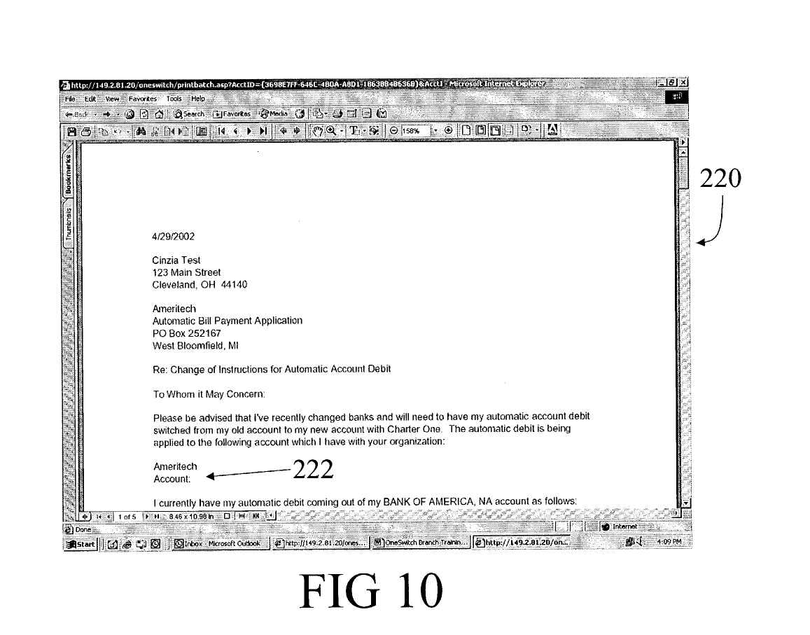

FIG. 10 shows an exemplary display window 220 depicting correspondence generated in step 70 (see FIG. 2) by the notice forms processor 42 (see FIG. 1). The correspondence is generated using standard verbiage which is populated with information from the user's personal profiles including the user's name and address, the entity's name and address, and other information. In the event that an information item, e.g. the merchant account number, which was optional in the input window 180 is called for in the standard verbiage, that item is left blank 222 in the generated correspondence 220.

Although a personalized correspondence is preferably generated by the notice forms processor 42 in the step 70, in some instances this may be disadvantageous. For example, electronic social security deposit arrangements are updatable only telephonically. In this case, the correspondence construction step 70 preferably produces instructions for the user to follow in performing the telephonic social security deposit arrangement updating.

With continuing reference to FIGS. 1, 2, and 10, the correspondence generated by the notice forms processor 42 in the step 70 (FIG. 2) is communicated to the entities in a step 72. In one suitable method, correspondence such as that shown in the display window 220 is printed on the printer 30 and mailed to the entity by the user. In another suitable method, the correspondence is sent to the entity by electronic mail using the email server 32. For example, in FIG. 1 emailed correspondence directed to the mortgage company 16 and the employer 18 is indicated. Similarly, the notice forms processor 42 generates account close instructions which are sent to the old financial institution 12 by regular mail or electronic mail. It is also contemplated to communicate (step 72) the correspondence in other ways, such as by sending a facsimile (preferably electronically generated by the notice forms processor 42 and forwarded to a networked facsimile machine (not shown)).

Since many electronic money transfer arrangements require signed correspondence in order to effectuate an updating, such correspondence is preferably printed by the printer 30 so that the user can sign and mail the signed copy. However, it is also contemplated to communicate such correspondence electronically using a secure electronic signature if such electronically secured correspondence is accepted by the entity.

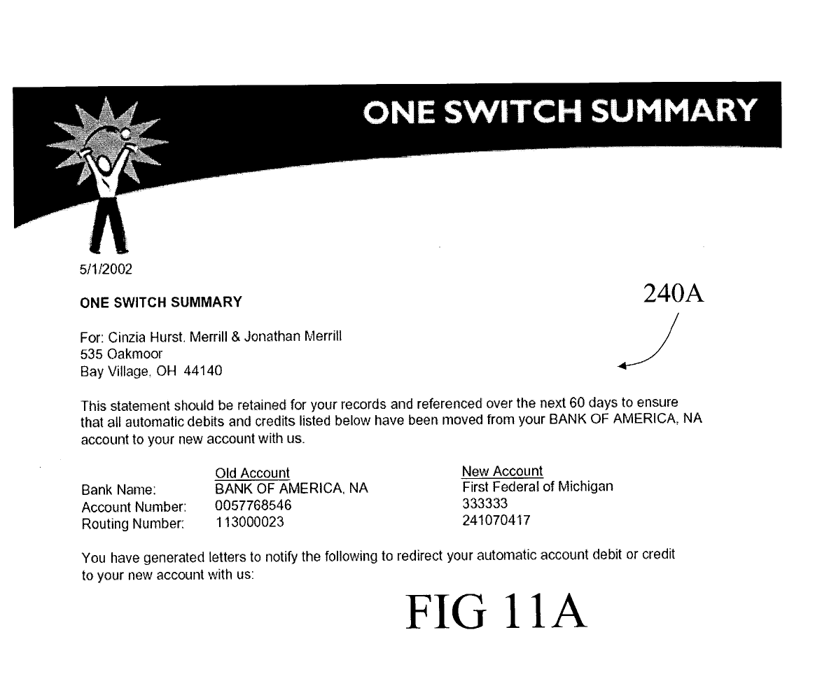

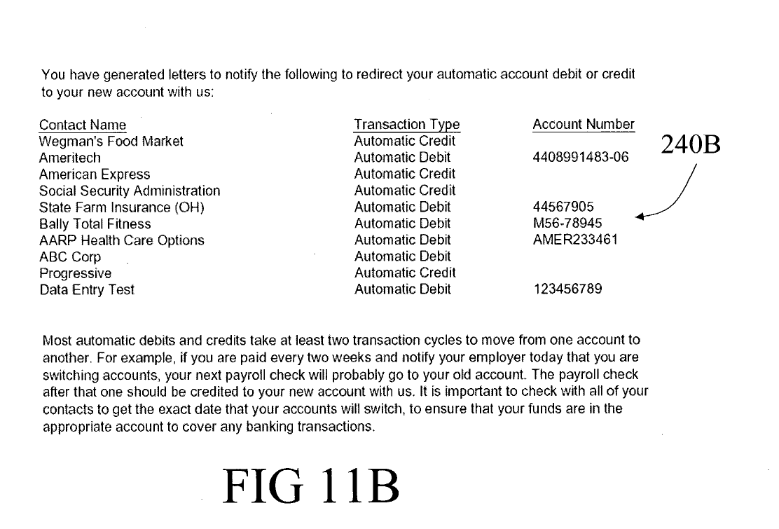

With continuing reference to FIGS. 1 and 2, and with further reference to FIGS. 11A and 11B, each item of correspondence that is printed, sent out by electronic mail, or otherwise communicated in the step 72 is recorded in the personal records archive 44 (see FIG. 1) in a step 74 (see FIG. 2). Preferably, the user receives a printed correspondence summary generated in a step 76 based on the contents of the personal records archive 44. An exemplary summary 240A, 240B is shown in FIGS. 11A and 11B. The automated records archiving step 74 ensures that the user can document money transfer arrangement change requests and related correspondence in the event that the updating is mishandled or otherwise defectively performed.

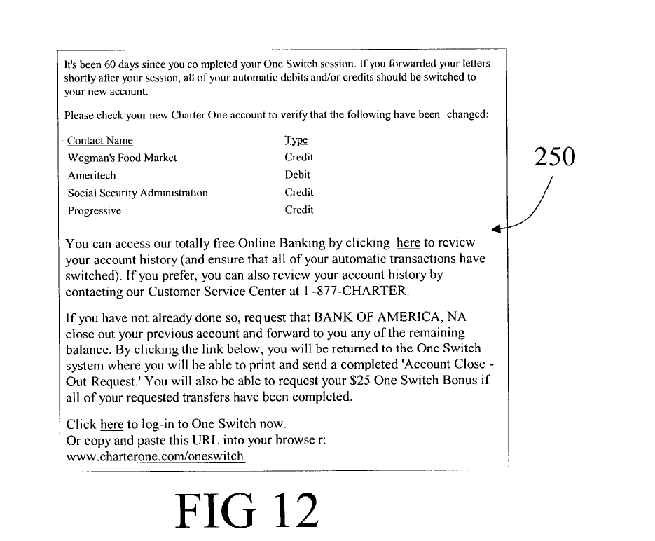

With continuing reference to FIGS. 1 and 2, and with further reference to FIG. 12, the new account is monitored in a step 80 (see FIG. 2). The monitoring provides the user with selected feedback and/or reminders about events which should occur during the transition from the old financial institution 12 to the new account 14 at the new financial institution. In a step 84, the monitoring detects a selected elapsed time, e.g. sixty days, and sends a reminder notice 250 (see FIG. 12) to the user via the email server 32 in a step 86. The exemplary reminder notice 250 reminds the user to verify that the identified automatic money transfer arrangements are properly communicating with the new account 14. Of course, the text of the reminder notice 250 is exemplary only, and can be suitably modified to address particular situations. Furthermore, multiple reminders are preferably sent, for example at forty-five days and at sixty days. If the user does not have convenient electronic mail access, it is also contemplated to send facsimile reminders, telephonic reminders, and/or the like. Preferably, a telephonic reminder transmits a computer-generated message.

It will be appreciated that the reminders 86 greatly reduce the likelihood that the user will be adversely affected by a defective updating of a money transfer arrangement (e.g., defective due to an error by the user or the associated entity) that results in disruption of the automated money transfer arrangement. Optionally, the reminders are also stored in the personal records archive 44. This recording benefits the new financial institution by documenting its communications with the user.

In addition to the automatic reminders sent in the step 86, the account transfer system 10 also preferably receives electronic communications from the new account 14 when selected transactions occur, such as one of the automatic money transfers. If such an automatic money transfer is detected in a step 90, the notice forms processor 42 prepares and communicates an alert 92 to the user indicating the transfer has occurred. The alert 92 is transmitted by the email server 32, by a PDA or cellphone 46, or the like. Multiple alert pathways can also be utilized. A suitable exemplary telephonic message that is computer generated reads:

Good morning. This is Charter One Bank. We're calling to notify you that on Apr., 20th, 2002 an automatic account debit for $22.22 from American Express posted to your Charter One checking account ending in 200039. Thank you and have a good day.

Of course, those skilled in the art can generate other suitable messages that are targeted toward particular users or situations. The detection and alert steps 90, 92 beneficially notify the user when an automatic money transfer arrangement accesses the new account 14, so that the user does not have to repetitively check the account status to verify that the automatic money transfer arrangement has properly switched over to using the new account 14.

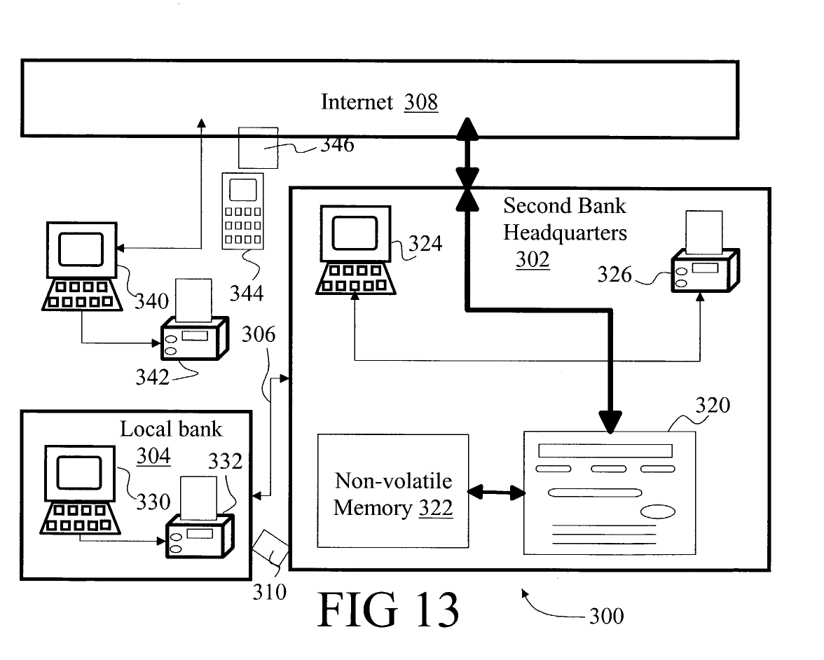

With continuing reference to FIG. 1, and with further reference to FIG. 13, a suitable embodiment 300 of the account transfer system 10 with respect to communication pathways and a distributed organization of the new financial institution is described. As is known to those skilled in the art, a typical financial institution such as the exemplary second institution has a main headquarters 302 and a plurality of branch locations, exemplary represented in FIG. 13 by a local bank 304. The main headquarters 302 and the local branches 304 communicate electronically, for example via dedicated lines 306, the Internet 308, wireless communication links 310, or other or additional pathways. The main headquarters 302 includes a centralized computing system 320 including a non-volatile electronic storage medium 322 such as a magnetic or optical disk or array of disks, on which the account transfer system 10 resides, typically along with account data such as account data for the new account 14. The centralized computing system 320 also optionally includes the email server 32. The main headquarters 302 preferably also includes one or more user terminals 324 (preferably graphical) through which the GUI of the account transfer system 10 can be accessed, and printers 326 and through which correspondence can be printed.

In a typical embodiment, the account transfer system 10 is embodied as a computer program stored on the non-volatile electronic storage medium 322, such as an electronic diskette, optical storage medium, electronic memory, or the like. The computer program is executable on one or more computers of the centralized computing system 320 to effectuate method steps such as the method 60 that assist the user in navigating the account transfer process.

However, the main headquarters 302 is typically inaccessible to many (and often most) of the bank's customers. Hence, the local branch locations 304 also include GUI user terminals 330 and printers 332 through which the user can access and manipulate the account transfer system 10 via one of the electronic communication pathways 306, 308, 310, optionally with the assistance of a bank employee.

Even the branch locations 304 can be inconvenient for users, however. For example, the user may want to access the account transfer system 10 when the branch 304 is closed, or the bank may have a line of waiting customers. If the user does not need assistance from a branch employee, the user can optionally access the account transfer system 10 via the Internet using a home personal computer (pc) 340 to interact with the GUI as a web-based application, and a connected printer 342 to print out the generates correspondence. Optionally, the user can also interact with the account transfer system 10 by a cellular telephone 344 or other data communication device employing wireline or wireless communication pathway 346, for example to receive the reminders 86 and the alerts 92 shown in FIG. 2.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A method for transferring an old account at a first financial institution to a new account at a second financial institution wherein the old and new accounts belong to a selected person, the method comprising:
creating a personal profile corresponding to the selected person, the personal profile including at least:
identification information identifying the selected person,
identifying information identifying the old account,
identifying information identifying the new account, and
a security password;
creating a contact list including information corresponding to an associated entity that conducts automatic transactions including one of debiting and crediting the at least one old account;
contacting the associated entity to instruct the entity to conduct the automatic transactions using the new account subsequent to a first date; and
contacting the first financial institution to effectuate a closing of the old account at a selected second date.

2. The method as set forth in claim 1, wherein the steps of creating a contact list and contacting the associated entity include:
receiving identifying information for the associated entity;
identifying the associated entity in a first electronic information database;
copying information in the first electronic information database corresponding to the associated entity into the personal profile; and
based on the personal profile, constructing a communication instructing the entity to conduct the automatic transactions using the new account subsequent to the first date.

3. The method as set forth in claim 2, wherein the contacting of the associated entity includes:
transmitting the constructed communication to the associated entity by electronic mail.

4. The method as set forth in claim 2, wherein the contacting of the associated entity includes:
printing the constructed communication in a mailable format.

5. The method as set forth in claim 1, wherein the contacting of the first financial institution to effectuate a closing of the old account at a selected second date includes:
identifying the first financial institution in a second electronic information database;
copying information in the second electronic information database corresponding to the first financial institution into the personal profile; and
based on the information in the personal profile, constructing a communication instructing the first financial institution to effectuate a closing of the old account at the selected second date.

6. The method as set forth in claim 5, wherein the contacting of the first financial institution further includes:
transmitting the constructed communication to the first financial institution by electronic mail.

7. The method as set forth in claim 5, wherein the contacting of the first financial institution further includes:
printing the constructed communication in a mailable format.

8. An apparatus for transferring an old account at a first financial institution to a new account at a second financial institution wherein the old and new accounts belong to a selected person, the apparatus comprising:
a personal profile database including a profile of the selected person;
a user interface through which information pertaining to the selected person is entered into the profile of the selected person, the entered information including at least:
identification information identifying the selected person,
identifying information identifying the old account,
identifying information identifying the new account, and
identifying information identifying an associated entity that performs automatic money transfers into or out of the old account;
a financial institution database containing information on a plurality of financial institutions, wherein information in the financial institution database corresponding to the first financial institution is transferred into the profile of the selected person;
an entities database containing information on a plurality of entities that conduct financial transactions including automatic electronic money transfers, wherein information in the entities database corresponding to the associated entity is transferred into the profile of the selected person; and
a scheduling processor communicating with the personal profile database that constructs a first communication instructing the associated entity to switch the automatic money transfers to the new account at a first date, and that constructs a second communication instructing the first financial institution to close the old account at a second date.

9. The apparatus as set forth in claim 8, further including:
an electronic mail server that electronically transmits the first communication to the associated entity conditional upon the profile of the selected person including an electronic mail address for the associated entity.

10. The apparatus as set forth in claim 8, further including:
an electronic mail server that electronically transmits the second communication to the first financial institution conditional upon the profile of the selected person including an electronic mail address for the first financial institution.

11. The apparatus as set forth in claim 10, wherein the scheduling processor cooperates with the electronic mail server to send reminder electronic mails to the selected person that remind the selected person to verify successful switching of an automatic money transfer arrangement.

12. The apparatus as set forth in claim 8, further including:
a printing device that receives a selected communication from the scheduling processor and prints the selected communication on paper.

13. The apparatus as set forth in claim 12, wherein the selected communication includes instructions to the selected person for switching an automatic money transfer arrangement from the old account to the new account, the instructions including identifying information about the first financial institution, the second financial institution, and the new account to effectuate the switching.
